(19) United States
(12) Patent Application Publication
(10) Pub. No.: US 2011/0261880 A1
(43) Pub. Date: Oct. 27, 2011

(54) BOUNDARY ADAPTIVE INTRA PREDICTION FOR IMPROVING SUBJECTIVE VIDEO QUALITY

(75) Inventor: Cheung Auyeung, Sunnyvale, CA (US)

(73) Assignee: SONY CORPORATION, Tokyo (JP)

(21) Appl. No.: 13/077,751

(22) Filed: Mar. 31, 2011

Related U.S. Application Data
(60) Provisional application No. 61/328,419, filed on Apr. 27, 2010.

(51) Int. Cl. H04N 7/26

(52) U.S. Cl. 375/240.12; 375/E07.243

(57) ABSTRACT

Described herein are apparatus and methods for enhancing perceived visual quality of video which has been coded using enhanced intra predictive coding referred to as boundary adaptive intra predictions (BAIP). BAIP is performed in response to the type of prediction, and the smoothness of the boundary between a current block and its neighboring pixels which have already been coded. Intra prediction is performed separately for each pixel along the left side and/or top side within a current block, which takes into account the pixel itself and multiple pixels along the left and/or top border of that current block. The BAIP technique can be applied for different block sizes, including 4×4, 8×8, and 16×16, and includes vertical, horizontal, and DC intra predictions.

### CROSS-REFERENCE TO RELATED APPLICATIONS

This application claims priority from U.S. provisional application Ser. No. 61/328,419 filed on Apr. 27, 2010, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to intra predictive video coding devices, and more particularly to directional intra predictions.

2. Description of Related Art

Efficiently storing and/or communicating images and videos requires advanced coding mechanisms for reducing spatial redundancies, temporal redundancies, or a combination of temporal and spatial redundancies. Numerous coding techniques are directed toward fulfilling that goal and continuous efforts are being made toward increased encoder and decoder efficiencies.

Advanced video coding techniques, such as described within the H.264/AVC standard, utilize both spatial and temporal predictions to increase coding gain. Efficiently encoding a video bitstream generally involves block partitioning, prediction, executing a transform, quantization, coefficient scanning and entropy encoding. Decoding of encoded video by a decoder is performed substantially in the reverse process.

Exploiting spatial redundancy between samples within a frame (e.g., frame, image, slice, group of macroblocks) is referred to as intra prediction. The advanced video coding standard (i.e., H.264/AVC) supports intra prediction, including adaptive block sizes of 4×4 and 8×8 blocks. AVC is currently one of the most commonly used formats for the recording, compression, and distribution of high definition video.

When a block or macroblock is encoded in the intra mode (intra prediction mode) of AVC, a prediction block is generated in response to previously encoded and reconstructed blocks. This prediction block is subtracted from the current block prior to encoding. When considering luminance (luma) samples, the prediction block can be formed for each 4×4 subblock or for a 16×16 macroblock. AVC provides a total of nine (9) prediction modes for each 4×4 luma block, four (4) prediction modes for a 16×16 luma block, while having four (4) modes which are applied to each 4×4 chroma block. During coding, the blocks or macroblocks are sequentially coded within each frame or slice.

The perceived visual quality of video which has been coded in response to intra predictive coding is subject to certain limitations.

Accordingly, the present invention is directed at overcoming certain visual quality limitations which arise during intra prediction.

### BRIEF SUMMARY OF THE INVENTION

Perceived visual quality of intra coded video is enhanced intra in response to using boundary adaptive intra predictions (BAIP) according to the invention. Previously, in AVC intra prediction, the current block was intra predicted from the adjacent previously decoded blocks before they were deblocked, with more prediction error being observed at the first top row and the first left column of the current block. Others have not addressed this higher prediction error problem which arises at the first top row and the first left columns of the current block.

BAIP is performed in response to the type of prediction, and the smoothness of the boundary between a current block and its neighboring pixels which have already been coded. Intra prediction is performed separately for each pixel along the left side and/or top side within a current block, which takes into account the pixel itself and multiple pixels along the left and/or top border of that current block. For example, when the top and/or left block boundaries are smooth, the top boundary and left boundary pixels outside of the current block are used for predicting the pixels inside the top and/or left edge of the current block, with the prediction for each pixel being determined separately if the boundary is sufficiently smooth.

The BAIP technique can be applied for different block sizes, including 4×4, 8×8, and 16×16, and includes vertical, horizontal, and DC intra predictions.

The invention is amenable to being embodied in a number of ways, including but not limited to the following descriptions.

One embodiment of the invention is an apparatus for video coding using intra prediction, comprising: (a) a computer configured for processing video signals associated with a video coding device; (b) a memory coupled to the computer; and (c) programming configured for retention on the memory and executable on the computer for direction prediction during intra prediction within the video coding device with steps comprising, (c)(i) determining a smoothness value between a multiple pixel boundary of a current block and adjacent pixels, (c)(ii) performing a boundary adaptive intra prediction, if in response to a comparison between the smoothness value and a smoothness threshold it is determined that the boundary of the current block is sufficiently smooth in relation to the adjacent pixels, (c)(iii) computing prediction values according to replacement value operations for pixels along at least one boundary inside the current block in response to pixel values bordering the at least one boundary which are outside of the current block, and (c)(iv) completing intra prediction coding of the current block in response to the prediction values.

At least one embodiment of the invention is configured for predictions involving blocks, and the current block, having various sizes, such as comprising 4×4 blocks, 8×8 blocks, or 16×16 blocks. At least one embodiment of the invention programming is configured for determining that the current block is not at the top row or left column of a frame prior to performing the boundary adaptive intra prediction, as this limits available coded neighbor information. At least one embodiment of the invention is configured with the smoothness value determined in response to coding characteristics comprising: coding mode of adjacent blocks, quantization parameter step size, and the gradient between blocks. At least one embodiment of the invention is configured to perform the threshold comparisons in response to information utilized or generated within a deblocking filter of the video coding device and utilized for performing the boundary adaptive intra prediction. At least one embodiment of the invention is configured for with the smoothness threshold preferably having a boundary strength of four.

At least one embodiment of the invention is configured for making the comparison in response to comparing the absolute differences between pixels inside and outside the current block, bordering along the boundary of the current block, against a deblocking filter value determined in response to quantization parameter step size. At least one embodiment of the invention is configured for utilizing a deblocking filter value that comprises alpha (α) or beta (β), used for controlling deblocking filter strength.

At least one embodiment of the invention is configured so that the block boundary across which difference comparisons are made comprise pixels on a left edge and/or a top edge of the current block. At least one embodiment of the invention is configured so that the boundary adaptive intra prediction comprises a vertical prediction in which each pixel in a column along the left of the current block is predicted in response to averaging the prediction value of a pixel above the column with the pixel value to the left of each the pixel, which is outside of the current block. At least one embodiment of the invention is configured with the boundary adaptive intra prediction comprising a horizontal prediction in which each pixel in a row along the top of the current block is predicted in response to averaging the prediction value of a pixel to the left of the row, with the pixel value above each the pixel, which is outside of the current block. At least one embodiment of the invention is configured with the boundary adaptive intra prediction comprising a DC prediction in which each pixel in a column at the left of the current block, or each pixel in a row along the top of the current block, or a combination of each pixel in a column at the left of the current block and each pixel in a row along the top of the current block, are predicted in response to averaging the prediction value of each the pixel with an average value obtained from the pixels outside of the current block which border the left side and top side of the current block. At least one embodiment of the invention is configured so that if the comparison indicates that the boundary of the current block is not sufficiently smooth in relation to the adjacent pixels, then prediction is performed conventionally without taking into account each of the pixel values bordering the at least one boundary.

One embodiment of the invention is an apparatus for video coding using intra prediction, comprising: (a) a computer configured for processing video signals associated with a video coding device; (b) a memory coupled to the computer; and (c) programming configured for retention on the memory and executable on the computer for direction prediction during intra prediction within the video coding device with steps comprising, (c)(i) determining a smoothness value between a multiple pixel boundary of a current block and adjacent pixels, (c)(ii) wherein the smoothness value is determined in response to coding characteristics, such as preferably comprising: coding mode of adjacent blocks, quantization parameter step size, and the gradient between blocks, (c)(iii) performing a boundary adaptive intra prediction if in response to a comparison between the smoothness value and a smoothness threshold it is determined that the boundary of the current block is sufficiently smooth in relation to the adjacent pixels, (c)(iv) computing prediction values according to replacement value operations for pixels along at least one boundary inside the current block in response to pixel values bordering the selected boundary (e.g., horizontal and/or vertical) which are outside of the current block, and (c)(v) completing intra prediction coding of the current block in response to the prediction values.

One embodiment of the invention is a method of intra predictive video coding within a video coding device, comprising: (a) processing video signals associated with a video coding device having a computer which executes programming for performing direction prediction during intra prediction; (b) determining a smoothness value between a multiple pixel boundary of a current block and adjacent pixels; (c) performing a boundary adaptive intra prediction if in response to a comparison between the smoothness value and a smoothness threshold it is determined that the boundary of the current block is sufficiently smooth in relation to the adjacent pixels; (d) computing prediction values according to replacement value operations for pixels along at least one boundary inside the current block in response to pixel values bordering the at least one boundary which are outside of the current block; and (e) completing intra prediction coding of the current block in response to the prediction values.

The present invention provides a number of beneficial elements which can be implemented either separately or in any desired combination without departing from the present teachings.

An element of the invention is to perform enhanced intra prediction which takes into account multiple pixels along the left and/or top border of a current block, for each pixel along the left side and/or top side within a current block.

Another element of the invention is the performing of enhanced intra prediction for blocks which are not on the top row (highest row), or left column (leftmost column) of a frame.

Another element of the invention is the ability to perform enhanced intra prediction for blocks of different sizes, including 4×4, 8×8, 16×16 block sizes.

Another element of the invention is performing enhanced intra prediction for multiple prediction directions, including vertical prediction, horizontal prediction and DC prediction.

Another element of the invention is the use of smoothness detection from within a deblocking filter of a video coder as a measure of smoothness between pixels and whether the enhanced intra prediction described herein is to be performed on the current block.

A still further element of the invention is an enhanced prediction that can be implemented in devices and systems which incorporate video encoding and/or decoding.

Further elements of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a schematic of a video coder configured for performing boundary adaptive intra predictions according to an embodiment of the present invention.

FIG. 2 is a diagram of a vertical boundary between pixels inside and outside of a current block subject to intra prediction.

FIG. 3A and FIG. 3B are diagrams of vertical intra prediction within a current block in relation to an adjacent row and column of pixels which have already been coded, and showing pixel prediction when boundary pixels are not smooth in FIG. 3A, and smooth in FIG. 3B.

FIG. 4A and FIG. 4B are diagrams of horizontal intra prediction within a current block in relation to an adjacent column and row of pixels which have already been coded, and showing pixel prediction when boundary pixels are not smooth in FIG. 4A, and smooth in FIG. 4B.

FIG. 5A through FIG. 5D are diagrams of DC intra prediction within a current block in relation to an adjacent row and column of pixels which have already been coded, and showing pixel prediction in response to different row and column smoothness.

FIG. 6 is a flowchart of boundary adaptive intra prediction according to an embodiment of the present invention, shown within a video coding device.

### DETAILED DESCRIPTION OF THE INVENTION

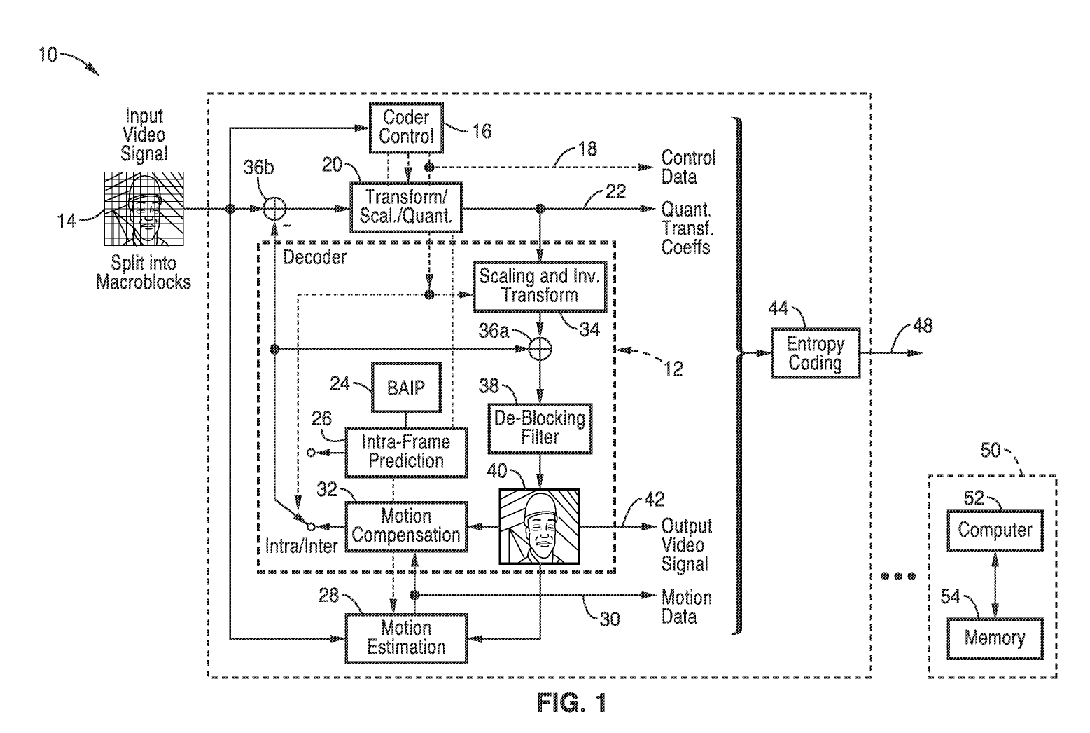

FIG. 1 illustrates an example video coding (encoder and/or decoder) embodiment 10 configured for boundary adaptive intra prediction (BAIP) according to the present invention. Although the present invention is shown implemented within an AVC (H.264) codec, it can be implemented in other intra predictive coding apparatus without departing from the teachings of the present invention. To provide for the prediction of subsequent blocks in the current picture or subsequent coded pictures, a decoder model is present within the encoder itself. Stated another way, it will be appreciated that a decoder is generally a subset of the functional elements of an encoder. The schematic of FIG. 1 depicts both an encoder 10, and a decoder 12 as a subset of encoder 10 for the sake of illustration. It will be appreciated, however, that in practice the decoder can be implemented entirely separately from any encoding functions, or may be implemented in a combination encoder-decoder.

A video input 14 is shown with a frame split into macroblocks (MBs). Coder control logic 16 is seen outputting control data 18. The blocks within the macroblock are predicted from previously encoded neighboring blocks. The difference 36b between video input 14 (the original signal) and the predicted blocks (the residual) is then transform coded with its resultant scaled and quantized in block 20 and quantized transform coefficients output 22.

The decoder section is shown here configured for both inter and intra prediction. In general the decoder performs an inverse of the operations performed by the encoder. It inverts the entropy coding process and then performs the prediction process utilizing motion data and operating in response to the type of selected prediction. Inverse scaling and transforming of the residual is also performed with a deblocking filter applied to the result to arrive at the video output.

Intra prediction exploits spatial redundancy in a video frame, with blocks in an intra predicted MB predicted only in response to the information from already coded MBs in the same frame. Usually intra prediction is performed when temporal prediction is not practical, or available. A block representing the additional programming associated with performing boundary adaptive intra prediction 24 is shown in the figure operating in cooperation with intra-frame prediction 26. It should be appreciated that the blocks shown in FIG. 1 are by way of example in regards to functions, whereas the actual programming need not have specific “modules” or “blocks” for the functions shown and described herein, which may be performed by any desired combination of programming executing on one or more processors within the coding device and any optional electronic acceleration hardware which is incorporated.

Inter prediction is depicted with motion estimation (ME) block 28 generating motion data 30, and coupled to motion compensation (MC) block 32. An inter prediction residual is shown generated in response to the sum 36a of the residual and the scaling and inverse transform 34 of quantized transform coefficients 22, which is filtered, such as through deblocking filter 38 to arrive at a video output signal 40. Inter coding utilizes motion compensation techniques for selecting motion data identifying the reference frame and spatial displacement vectors which are applied to predict the blocks of each macroblock.

In the encoder, quantized transform coefficients 22 and control data side information 18 are entropy coded 44 and transmitted as an encoded video signal 48 for storage and/or communication to be decoded at a later time and/or separate location.

The encoder/decoder apparatus is exemplified with a processing means 50, such as comprising at least one processing device (e.g., CPU) 52 and at least one memory 54 for executing programming associated with the encoding and/or decoding. In addition, it will be appreciated that elements of the present invention can be implemented as programming stored on a media, which can be accessed (i.e., directly, or indirectly after uploading to a memory) for execution by a CPU for the encoder and/or decoder.

This problem of higher prediction error at the first top row and the first left columns of the current block has not been previously recognized or addressed. A coder configured to provide boundary adaptive intra prediction 24 according to the invention will utilize the top boundary and left boundary pixels for intra predictions to improve visual quality when the top and/or left block boundaries are smooth.

For the sake of simplicity, the description herein refers to blocks being encoded from within a frame, however, it will be appreciated that the encoding can be considered to be upon a smaller grouping of pixels, such as within a sample, block or macroblock, which is contained within a larger grouping of pixels, such as comprising a group of blocks, frame, slice or similar.

In an industry standard configuration coding pass, the blocks which are located above and to the left of the current block within the frame, have been previously encoded and reconstructed, wherein they are available to the coder as a prediction reference. For example, when the current block is in the upper left corner of a frame, then no previous blocks have been coded in the frame. When the current block is in the upper row of a frame, then no neighbors above the current block have yet been coded, while if the current block is in the left column of a frame then no neighbors on the same row as the current block have yet been coded. It will be appreciated that the present invention is still applicable for coding passes which do not follow the conventional left to right and top to bottom scan path, such as in response to simply changing the directions and neighbor selection accordingly.

It should be recognized that in AVC intra prediction, the current block is intra predicted from the adjacent previously decoded blocks before they are deblocked. Therefore more prediction error was observed at the first top row and the first left column of the current block.

When the top and/or left block boundaries of the current block are smooth, then top boundary and left boundary pixels outside of the current block are also utilized according to the invention when performing intra predictions to improve the continuity between the adjacent decoded block(s) and the current block.

Apparatus and methods of the present invention are directed at improving the visual quality of encoded video with minimum impact on rate and distortion. It has been appreciated in the present invention that select intra predictions can be improved in response to utilizing boundary pixel information.

In particular, in a typical left-to-right, row-by-row coding pattern from top to bottom of the frame, when it is detected that the top and/or left block boundaries are smooth, then these top boundary and/or left boundary pixels (just outside the boundary of the current block) are utilized within the invention when performing the intra prediction to increase visual quality.

Boundary smoothness can be determined in a number of ways without departing from the present invention. In one implementation of the invention, the extent of smoothness of the boundary is already determined within the coding system for use by the deblocking filter, such as within the AVC/H.264 standard, which simplifies implementation and overhead in the coding system.

It should be noted that in AVC standards (e.g., H.264) the deblocking filter is incorporated into both the decoding and encoding path, it is not optional. In this way the in-loop effects of the filter are taken into account in reference macroblocks which are used for prediction. During video encoding, filter strength is selectable, while the filter can be deselected entirely. When operating, filter strength is determined in the H.264 standard by coding modes of adjacent blocks, quantization step size (QP), and steepness (slope) of luminance gradient between blocks. Boundary strength on small blocks (e.g., 4×4 and 8×8) is assigned a boundary strength in response to: (1) coincidence of boundaries (e.g., whether it is also on a macroblock boundary), (2) whether the block is intra coded or inter coded, (3) whether there is a difference in references for motion prediction and reference frame choice, and (4) whether it is a luma or chroma edge. Stronger levels of filtering are assigned according to these techniques when the blocks are subject to higher levels of distortion. The filters are configured to modify as many as three pixels (or samples) on either side of a given block edge, such as one or two samples on either side of the edge, depending on quantization step size, filter strength tuning by the encoder, information from an edge detection test, and can additionally include other factors.

In AVC the filter is applied to both vertical and horizontal edges of 4×4 luma or chroma blocks within a macroblock, with the strength (extent) of filtering determined in response to boundary strength (bS), as determined by factors discussed above, including the average quantizer parameter (step size) (QP) of the two sides of an edge, coding modes of adjacent blocks, and gradient across the edge. Two thresholds are defined in AVC, specifically alpha (α) and beta (β), that depend on average QP of adjacent blocks and provide additional boundary information for deciding whether to perform filtering on the current boundary or not. The α and β values increase or decrease in response to increases or decreases, respectively, in the value of QP. Levels of boundary strength can thus be represented by α(QP) and β(QP).

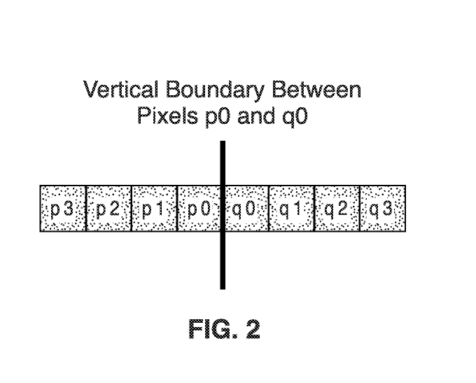

FIG. 2 illustrates conditions for smoothness detection according to the invention. A vertical boundary is shown by way of example between pixels, with pixels to the left of the boundary represented by p0, p1, p2 and p3 and pixels to the right of the boundary represented by q0, q1, q2 and q3. It will be appreciated that the larger the number the farther the pixel is located from the boundary, with p0 for example adjacent the boundary, p1 adjacent p0 and one pixel away from the boundary, and pixel p3 being adjacent to pixel p2 and is three pixels away from the boundary. For the sake of simplicity of illustration, the pixels shown are only those along a traverse direction to the boundary with neighboring pixels hidden. It should be appreciated that the boundary and traversing pixels may be disposed in different directions according to any of multiple direction modes (e.g., vertical, horizontal) without departing from the teachings herein.

In one implementation, the block boundary is considered to be smooth when two blocks adjacent to the boundary are intra coded, for example when a boundary strength is equal to four (4) which is a condition on which the AVC deblocking filter would be activated. Referring to FIG. 2, the boundary between p0 and q0 is considered smooth according to one example implementation when the following conditions are true;

P side and Q side of the boundary are both intra coded; (1)

Value of |p0−q0|<α(QP); (2)

Value of |p1−p2|<β(QP); and (3)

Value of |q1−q2|<β(QP). (4)

It should be appreciated that different conditions can be selected without limitation for controlling BAIP according to the present invention. The selection of boundary conditions will typically depend on what boundary detection already exists on the given coding system, the overhead sensitivity of the application and quality considerations for the given application.

By way of example and not limitation, the above form of boundary smoothness detection is described for use in different prediction situations as exemplified in the following sections.

The BAIP enhanced prediction can be applied to multiple directions of prediction according to the present invention. By way of example, and not limitation, the embodiments are described for applying BAIP to vertical, horizontal, and DC predictions of 4×4, 8×8, and 16×16 blocks.

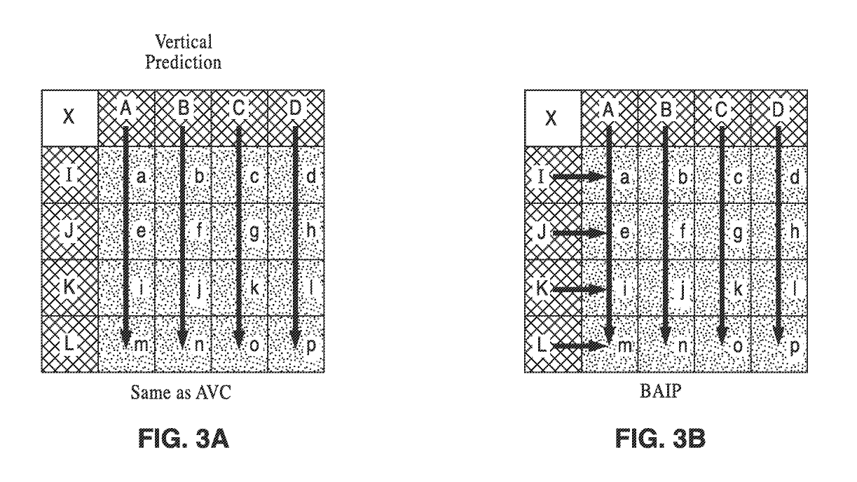

FIGS. 3A and 3B illustrate 4×4 vertical intra prediction according to an embodiment of the invention within a grid of pixels. AVC vertical intra prediction is performed and if the block is not in the top row or left most column of a picture, where there is a lack of pixels A, B, C, D or I, J, K, L, then a check is made to determine if the boundary is sufficiently smooth to apply enhanced prediction.

In FIG. 3A a traditional form of AVC prediction is performed when X and A pixels are not sufficiently smooth, that is, the difference between the pixels X and A is not up to the established smoothness threshold conditions, such as described above. In the traditional prediction pixels a, e, i and m are predicted by A.

FIG. 3B illustrates prediction performed according to the invention when the transition between X and A is sufficiently smooth, at which time pixel predictions values are replaced according to a set replacement values operations which map a replacement values based on the original prediction combined with a boundary pixel, exemplified as the following:

a=(A+I+1)>>1;

b=(A+J+1)>>1;

c=(A+K+1)>>1; and

d=(A+L+1)>>1.

It will be appreciated in the above that the double greater-than-signs “>>” represent a right shift operation. Accordingly, a form of averaging is performed in which the pixel prediction values are summed, offset by 1, and then divided by two in response to the right shift of one bit. It should be appreciated that implementations of the present invention can be adapted to perform any desired form of averaging or combination of pixel values without limitation, and without departing from the teachings of the present invention.

It should be appreciated that the 4×4 blocks in the above figures and the following figures, are depicted by way of example. BAIP can be applied in a similar manner to larger blocks, such as 8×8 and 16×16 blocks by continuing the same pattern of prediction calculations for each pixel inside the current block which borders the left and of top of the current block.

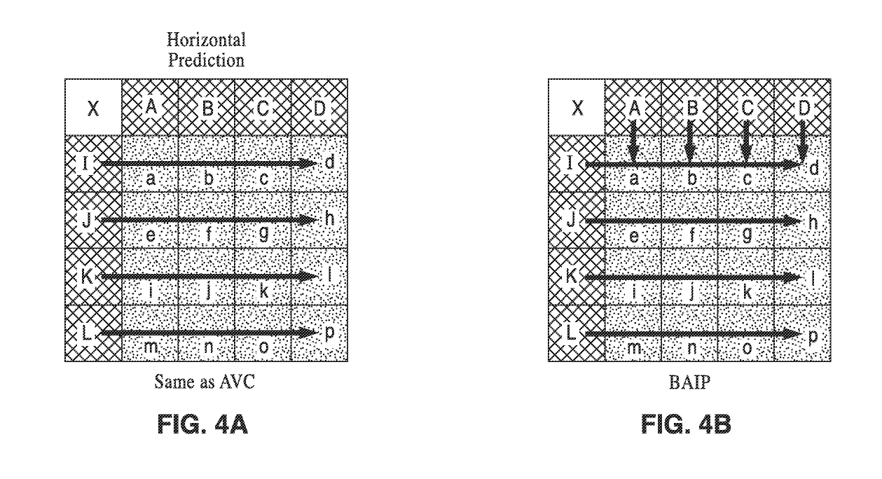

FIGS. 4A and 4B illustrate a similar 4×4 intra prediction being performed for a horizontal direction of prediction. AVC horizontal intra prediction is performed and if the block is not in the top row or left most column of a picture, then a determination is made to determine if the boundary is sufficiently smooth to apply enhanced prediction as follows:

a=(I+A+1)>>1;

b=(I+B+1)>>1;

c=(I+C+1)>>1; and

d=(I+D+1)>>1.

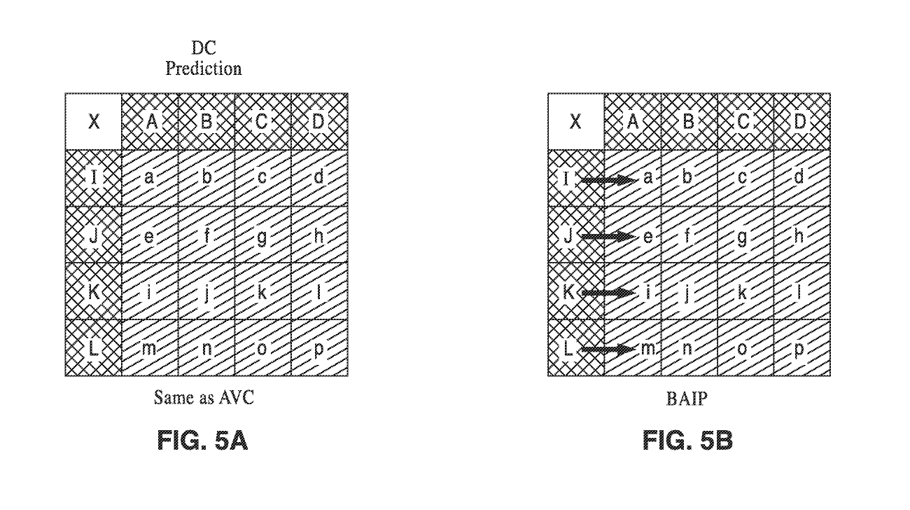

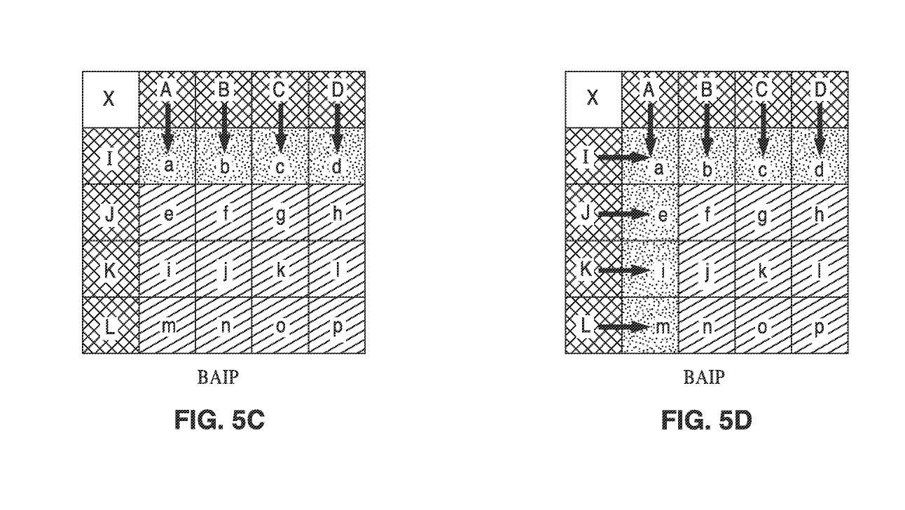

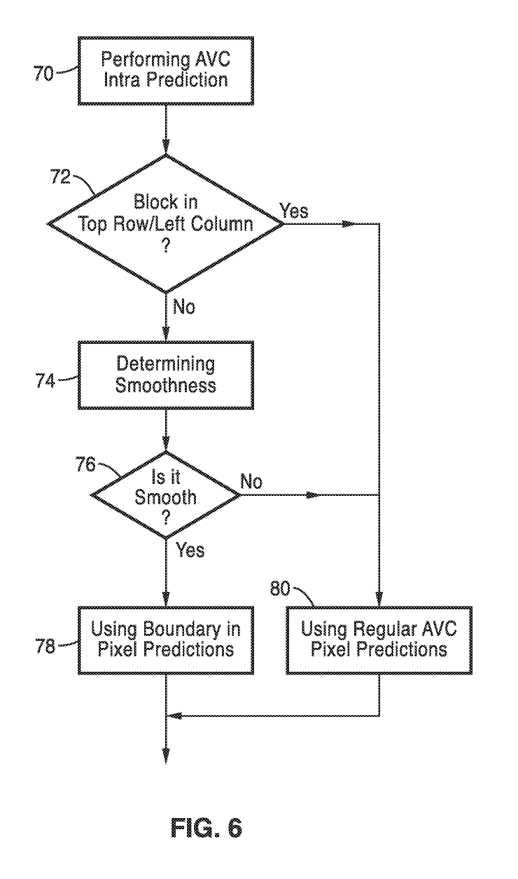

FIG. 5A through FIG. 5D illustrate a 4×4 DC intra prediction being performed according to the invention. A DC prediction is performed, and a substitutionary DC value created s0. In one implementation the substitution value s0 is determined as:

s0=(A+B+C+D+I+J+K+L+4)/8.

If the block is not in the top row or left most column of a frame, then a determination is made as to whether a typical AVC DC prediction is performed based on a how the pixels compare to a smoothness threshold.

In FIG. 5A, neither the edges of the block are not smooth in either the vertical or horizontal directions, then BAIP is not utilized and prediction is performed without this enhancement, such as following standard AVC DC prediction.

FIG. 5B illustrates a situation when the transition from A to X is smooth, but the transition of I to X is not smooth, in which case pixel predictions for a, e, i, m are determined as follows;

a=(s0+I+1)>>1;

e=(s0+J+1)>>1;

i=(s0+K+1)>>1; and

m=(s0+L+1)>>1.

In a converse manner, when I to X is smooth, but transition A to X is not smooth, then predictions are performed for pixels a, b, c, d as follows:

a=(s0+A+1)>>1;

b=(s0+B+1)>>1;

c=(s0+C+1)>>1; and

d=(s0+D+1)>>1.

However, if A to X is smooth and also I to X is smooth, then the left column and upper rows of pixels comprising a, b, c, d, e, i, m are predicted as follows:

a=(I+A+1)>>1;

b=(s0+B+1)>>1;

c=(s0+C+1)>>1;

d=(s0+D+1)>>1;

e=(s0+J+1)>>1;

i=(s0+K+1)>>1; and

m=(s0+L+1)>>1.

Results obtained with BAIP are shown in Table 1 with respect to four

Class C sequences of 240 frames per sequence. These sequences were chosen to provide good comparative testing. To perform the comparison, encoding was performed using traditional AVC without BAIP, then by utilizing AVC adapted with BAIP according to the present invention. A % BD (Bjøntegaard Delta) rate change determination was made for comparing the rate distortions on these sequences. It can be seen from Table 1, that BAIP had little impact on the overall rate-distortion (R-D). It was noted visually that the flickering in large flat areas was reduced with those details increased, while in some busy areas detail was slightly reduced.

Accordingly, the present invention provides methods and apparatus for improving intra prediction where smooth block boundaries exist. Inventive teachings can be applied in a variety of apparatus and applications, including video encoders and decoders, and other electronic devices which utilize video encoding and/or decoding.

From the description herein, it will be further appreciated that the invention can be embodied in various ways, which include but are not limited to the following.

1. An apparatus for video coding using intra prediction, comprising: (a) a computer configured for processing video signals associated with a video coding device; and (b) programming executable on said computer for direction prediction during intra prediction within the video coding device by performing steps comprising: (i) determining smoothness value between a multiple pixel boundary of a current block and adjacent pixels; (ii) performing a boundary adaptive intra prediction if in response to a comparison between said smoothness value and a smoothness threshold it is determined that said boundary of the current block is sufficiently smooth in relation to said adjacent pixels; (iii) computing prediction values according to replacement value operations for pixels along at least one boundary inside said current block in response to pixel values bordering said at least one boundary which are outside of said current block; and (iv) completing intra prediction coding of the current block in response to said prediction values.

2. The apparatus of embodiment 1, wherein said current block comprises a 4×4 block, 8×8 block, or a 16×16 block.

3. The apparatus of embodiment 1, further comprising programming executable on said computer for performing steps comprising determining that the current block is not at the top row or left column of a frame prior to performing said boundary adaptive intra prediction.

4. The apparatus of embodiment 1, wherein said smoothness value is determined in response to coding characteristics comprising: coding mode of adjacent blocks, quantization parameter step size, and the gradient between blocks.

5. The apparatus of embodiment 1, wherein said comparison is performed for use within a deblocking filter of said video coding device and utilized for performing said boundary adaptive intra prediction.

6. The apparatus of embodiment 1, wherein said smoothness threshold comprises a boundary strength of four.

7. The apparatus of embodiment 6, wherein said comparison is performed by comparing the absolute differences between pixels inside and outside said current block bordering, along the boundary of said current block, against a deblocking filter value determined in response to quantization parameter step size.

8. The apparatus of embodiment 7, wherein said deblocking filter value comprises alpha (α) or beta (β), used for controlling deblocking filter strength.

9. The apparatus of embodiment 1, wherein a boundary of said at least one boundary within said current block comprises pixels on a left edge of said current block.

10. The apparatus of embodiment 1, wherein a boundary of said at least one boundary within said current block comprises the pixels on a top edge of said current block.

11. The apparatus of embodiment 1, wherein said boundary adaptive intra prediction comprises a vertical prediction in which each pixel in a column along the left of said current block is predicted in response to averaging the prediction value of a pixel above said column with the pixel value to the left of each said pixel, which is outside of said current block.

12. The apparatus of embodiment 1, wherein said boundary adaptive intra prediction comprises a horizontal prediction in which each pixel in a row along the top of said current block is predicted in response to averaging the prediction value of a pixel to the left of said row, with the pixel value above each said pixel, which is outside of said current block.

13. The apparatus of embodiment 1, wherein said boundary adaptive intra prediction comprises a DC prediction in which each pixel in a column at the left of the current block, or each pixel in a row along the top of said current block, or a combination of each pixel in a column at the left of the current block and each pixel in a row along the top of said current block, are predicted in response to averaging the prediction value of each said pixel with an average value obtained from the pixels outside of said current block which border the left side and top side of said current block.

14. The apparatus of embodiment 1, wherein if said comparison indicates that said boundary of the current block is not sufficiently smooth in relation to said adjacent pixels, then prediction is performed conventionally without taking into account each of the pixel values bordering said at least one boundary.

15. An apparatus for video coding using intra prediction, comprising: (a) a computer configured for processing video signals associated with a video coding device; and (b) programming configured for retention on said memory and executable on said computer for direction prediction during intra prediction within the video coding device by performing steps comprising: (i) determining smoothness value between a multiple pixel boundary of a current block and adjacent pixels; (ii) wherein said smoothness value is determined in response to coding characteristics comprising: coding mode of adjacent blocks, quantization parameter step size, and the gradient between blocks; (iii) performing a boundary adaptive intra prediction if in response to a comparison between said smoothness value and a smoothness threshold it is determined that said boundary of the current block is sufficiently smooth in relation to said adjacent pixels; (iv) computing prediction values according to replacement value operations for pixels along at least one boundary inside said current block in response to pixel values bordering said at least one boundary which are outside of said current block; and (v) completing intra prediction coding of the current block in response to said prediction values.

16. The apparatus of embodiment 15, wherein said current block comprises a 4×4 block, 8×8 block, or a 16×16 block.

17. The apparatus of embodiment 15, further comprising programming executable on said computer for performing steps comprising determining that the current block is not at the top row or left column of a frame prior to performing said boundary adaptive intra prediction.

18. The apparatus of embodiment 15, wherein said comparison is performed for use within a deblocking filter of said video coding device and utilized for performing said boundary adaptive intra prediction.

19. The apparatus of embodiment 1, wherein a boundary of said at least one boundary within said current block comprises pixels on a left edge of said current block, or pixels on a top edge of said current block, or a combination thereof.

20. A method of intra predictive video coding within a video coding device, comprising: (a) processing video signals associated with a video coding device having a computer which executes programming for performing direction prediction during intra prediction; (b) determining smoothness value between a multiple pixel boundary of a current block and adjacent pixels; (c) performing a boundary adaptive intra prediction if in response to a comparison between said smoothness value and a smoothness threshold it is determined that said boundary of the current block is sufficiently smooth in relation to said adjacent pixels; (d) computing prediction values according to replacement value operations for pixels along at least one boundary inside said current block in response to pixel values bordering said at least one boundary which are outside of said current block; and (e) completing intra prediction coding of the current block in response to said prediction values.

Embodiments of the present invention are described with reference to flowchart illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory or media that can direct a computer or other programmable processing apparatus to function in a particular manner, such that the instructions stored in the computer-readable memory or media produce an article of manufacture including instruction means which implement the function specified in the block(s) of the flowchart(s). Computer readable media according to the present invention include electronic memory devices without limitation (e.g., static, dynamic, removable, programmable, and so forth) as well as media storage devices (e.g., fixed disk media, removable disk media, and so forth) are not construed herein to include transitory electronic signals, although memory devices may be controlled in response to transitory electronic signals. The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Change in BD Rate with BAIP

| | Hi Rate | Low Rate |
|---|---|---|
| C08_BasketBallDrill | 0.11 | 0.13 |
| C09_BQMall | 0.10 | 0.21 |
| C10_PartyScene | −0.12 | −0.04 |
| C11_RaceHorse | −0.10 | −0.10 |
| Average | 0.00 | 0.05 |

What is claimed is:

1. An apparatus for video coding using intra prediction, comprising:
a computer configured for processing video signals associated with a video coding device; and
programming executable on said computer for direction prediction during intra prediction within the video coding device by performing steps comprising:
determining smoothness value between a multiple pixel boundary of a current block and adjacent pixels;
performing a boundary adaptive intra prediction if in response to a comparison between said smoothness value and a smoothness threshold it is determined that said boundary of the current block is sufficiently smooth in relation to said adjacent pixels;
computing prediction values according to replacement value operations for pixels along at least one boundary inside said current block in response to pixel values bordering said at least one boundary which are outside of said current block; and
completing intra prediction coding of the current block in response to said prediction values.

2. An apparatus as recited in claim 1, wherein said current block comprises a 4×4 block, 8×8 block, or a 16×16 block.

3. An apparatus as recited in claim 1, further comprising programming executable on said computer for performing steps comprising determining that the current block is not at the top row or left column of a frame prior to performing said boundary adaptive intra prediction.

4. An apparatus as recited in claim 1, wherein said smoothness value is determined in response to coding characteristics comprising: coding mode of adjacent blocks, quantization parameter step size, and the gradient between blocks.

5. An apparatus as recited in claim 1, wherein said comparison is performed for use within a deblocking filter of said video coding device and utilized for performing said boundary adaptive intra prediction.

6. An apparatus as recited in claim 1, wherein said smoothness threshold comprises a boundary strength of four.

7. An apparatus as recited in claim 6, wherein said comparison is performed by comparing the absolute differences between pixels inside and outside said current block bordering, along the boundary of said current block, against a deblocking filter value determined in response to quantization parameter step size.

8. An apparatus as recited in claim 7, wherein said deblocking filter value comprises alpha (α) or beta (β), used for controlling deblocking filter strength.

9. An apparatus as recited in claim 1, wherein a boundary of said at least one boundary within said current block comprises pixels on a left edge of said current block.

10. An apparatus as recited in claim 1, wherein a boundary of said at least one boundary within said current block comprises the pixels on a top edge of said current block.

11. An apparatus as recited in claim 1, wherein said boundary adaptive intra prediction comprises a vertical prediction in which each pixel in a column along the left of said current block is predicted in response to averaging the prediction value of a pixel above said column with the pixel value to the left of each said pixel, which is outside of said current block.

12. An apparatus as recited in claim 1, wherein said boundary adaptive intra prediction comprises a horizontal prediction in which each pixel in a row along the top of said current block is predicted in response to averaging the prediction value of a pixel to the left of said row, with the pixel value above each said pixel, which is outside of said current block.

13. An apparatus as recited in claim 1, wherein said boundary adaptive intra prediction comprises a DC prediction in which each pixel in a column at the left of the current block, or each pixel in a row along the top of said current block, or a combination of each pixel in a column at the left of the current block and each pixel in a row along the top of said current block, are predicted in response to averaging the prediction value of each said pixel with an average value obtained from the pixels outside of said current block which border the left side and top side of said current block.

14. An apparatus as recited in claim 1, wherein if said comparison indicates that said boundary of the current block is not sufficiently smooth in relation to said adjacent pixels, then prediction is performed conventionally without taking into account each of the pixel values bordering said at least one boundary.

15. An apparatus for video coding using intra prediction, comprising:
a computer configured for processing video signals associated with a video coding device; and
programming executable on said computer for direction prediction during intra prediction within the video coding device by performing steps comprising:
determining smoothness value between a multiple pixel boundary of a current block and adjacent pixels;
wherein said smoothness value is determined in response to coding characteristics comprising: coding mode of adjacent blocks, quantization parameter step size, and the gradient between blocks;
performing a boundary adaptive intra prediction if in response to a comparison between said smoothness value and a smoothness threshold it is determined that said boundary of the current block is sufficiently smooth in relation to said adjacent pixels;
computing prediction values according to replacement value operations for pixels along at least one boundary inside said current block in response to pixel values bordering said at least one boundary which are outside of said current block; and
completing intra prediction coding of the current block in response to said prediction values.

16. An apparatus as recited in claim 15, wherein said current block comprises a 4×4 block, 8×8 block, or a 16×16 block.

17. An apparatus as recited in claim 15, further comprising programming executable on said computer for performing steps comprising determining that the current block is not at the top row or left column of a frame prior to performing said boundary adaptive intra prediction.

18. An apparatus as recited in claim 15, wherein said comparison is performed for use within a deblocking filter of said video coding device and utilized for performing said boundary adaptive intra prediction.

19. An apparatus as recited in claim 1, wherein a boundary of said at least one boundary within said current block comprises pixels on a left edge of said current block, or pixels on a top edge of said current block, or a combination thereof.

20. A method of intra predictive video coding within a video coding device, comprising:
processing video signals associated with a video coding device having a computer which executes programming for performing direction prediction during intra prediction;
determining smoothness value between a multiple pixel boundary of a current block and adjacent pixels;
performing a boundary adaptive intra prediction if in response to a comparison between said smoothness value and a smoothness threshold it is determined that said boundary of the current block is sufficiently smooth in relation to said adjacent pixels;
computing prediction values according to replacement value operations for pixels along at least one boundary inside said current block in response to pixel values bordering said at least one boundary which is outside said current block; and
completing intra prediction coding of the current block in response to said prediction values.
